(19) United States
(12) Patent Application Publication
(10) Pub. No.: US 2013/0171419 A1
(43) Pub. Date: Jul. 4, 2013

(54) FLEXIBLE CUSTOM FLOOR MATS

(71) Applicant: Winfield Consumer Products, Inc., Strother Field, KS (US)

(72) Inventors: Robert D. Tyler, Winfield, KS (US); Kenneth Douglas Johnson, Derby, KS (US)

(73) Assignee: WINFIELD CONSUMER PRODUCTS, INC., Strother Field, KS (US)

(21) Appl. No.: 13/666,213

(22) Filed: Nov. 1, 2012

Related U.S. Application Data
(60) Provisional application No. 61/555,527, filed on Nov. 4, 2011.

(51) Int. Cl. B60N 3/04

(52) U.S. Cl. CPC B60N 3/04
USPC 428/167; 264/250

(57) ABSTRACT

An apparatus includes a bottom major surface configured to lie over and conform to contours of a vehicle floor surface; a top major surface opposite the bottom major surface having a base; an upwardly sloping wall portion extending from the base, the upwardly sloping wall portion configured to lie over and conform to contours of a vehicle surface; and a double wall disposed on the base at a location that is not on a perimeter of the apparatus, wherein the double wall comprises a plurality of ribs on the bottom major surface. The disclosure also describes a method including molding a label; inserting the molded label into a cavity of a mold; injecting a thermoplastic elastomer into the cavity to overmold the thermoplastic elastomer over at least portions of the label; curing the thermoplastic elastomer to form a mat; and removing the mat from the mold.

### CROSS REFERENCE TO RELATED APPLICATIONS

This application claims the benefit of priority from U.S. Provisional Patent Application No. 61/555,527, filed Nov. 4, 2011, entitled “Flexible Custom Floor Mats,” which is incorporated by reference in its entirety.

### BACKGROUND

Currently, many products are available for protecting floor and cargo areas of a vehicle against water, dirt, debris, and other elements. The most common product in this field is a mat. A mat is typically a piece of durable, pliable synthetic material having some sort of an outer wall for containing water, dirt, rocks or the like. The mat is set in a floor or cargo area of a vehicle in order to collect undesirable materials rather than having the materials accumulate on the surface of the floor or cargo area. It is generally easy to remove and clean a mat because its material is typically of a nature that is easy to shake out or hose off. Some but not all mats are carpeted, and in this case, it may be desirable to vacuum the mat. While mats often come with a vehicle when purchased, there are many after-market mats available from numerous commercial sources. In some cases, the after-market mats are of a higher quality than the mats that come with the vehicle from the factory. For example, an after-market mat may be made of a relatively more durable material.

Some mats may be designed for a custom or semi-custom fit. Custom mats are generally designed to closely and tightly engage the contours of the floor and/or cargo space of a particular vehicle, as designated by the vehicle's make, model and year. Thus, a custom mat for a particular 2010 Ford pickup truck is not likely to fit very well (at least without modification) into a Chevy pickup truck of the same year. On the other hand, a semi-custom floor mat is not made specifically for a vehicle floor and/or cargo space. Instead, semi-custom floor mats are designed to fit a large number of vehicles; they may not provide an especially tight fit relative to the contours of a particular vehicle's floor and/or cargo space. There are also mat products in the market that are intended to be of a “one size fits all” nature. Generally speaking, these mats are likely to even less closely fit to the contours of a given vehicle.

### SUMMARY

In one aspect, this disclosure describes an apparatus comprising a bottom major surface configured to lie over and conform to contours of a vehicle floor surface; a top major surface opposite the bottom major surface, the top major surface comprising a base; an upwardly sloping wall portion extending from the base, the upwardly sloping wall portion configured to lie over and conform to upwardly sloping contours of a vehicle surface; and a double wall disposed on the base at a location that is not on a perimeter of the apparatus, wherein the double wall comprises a plurality of ribs on the bottom major surface.

In another aspect, the disclosure describes a method of forming an apparatus comprising molding a label; inserting the molded label into a cavity of a mold; injecting a thermoplastic elastomer into the cavity to overmold the thermoplastic elastomer over at least portions of the label; curing the thermoplastic elastomer to form a mat; and removing the mat from the mold. The mat comprises a bottom major surface configured to lie over and conform to contours of a vehicle floor surface; a top major surface opposite the bottom major surface; and an upwardly sloping wall portion extending from the top major surface, the upwardly sloping wall portion configured to lie over and conform to upwardly sloping contours of a vehicle surface.

This summary is provided to introduce concepts in simplified form that are further described below in the Detailed Description. This summary is not intended to identify key features or essential features of the disclosed or claimed subject matter and is not intended to describe each disclosed embodiment or every implementation of the disclosed or claimed subject matter. Specifically, features disclosed herein with respect to one embodiment may be equally applicable to another. Further, this summary is not intended to be used as an aid in determining the scope of the claimed subject matter. Many other novel advantages, features, and relationships will become apparent as this description proceeds. The figures and the description that follow more particularly exemplify illustrative embodiments.

### BRIEF DESCRIPTION OF THE DRAWINGS

The disclosed subject matter will be further explained with reference to the attached figures, wherein like structure or system elements are referred to by like reference numerals throughout the several views.

FIG. 1A is a top perspective view of a first exemplary embodiment of a flexible custom floor mat of the present disclosure.

FIG. 1B is a bottom perspective view of the flexible custom floor mat of FIG. 1A.

FIG. 2A is a top perspective view of a second exemplary embodiment of a flexible custom floor mat of the present disclosure.

FIG. 2B is a bottom perspective view of the flexible custom floor mat of FIG. 2A.

FIG. 3 is a top perspective view of a third exemplary embodiment of a flexible custom floor mat of the present disclosure.

While the above-identified figures set forth one or more embodiments of the disclosed subject matter, other embodiments are also contemplated, as noted in the disclosure. In all cases, this disclosure presents the disclosed subject matter by way of representation and not limitation. It should be understood that numerous other modifications and embodiments can be devised by those skilled in the art which fall within the scope and spirit of the principles of this disclosure.

The figures may not be drawn to scale. In particular, some features may be enlarged relative to other features for clarity. Moreover, where tenus such as above, below, over, under, top, bottom, side, right, left, etc., are used, it is to be understood that they are used only for ease of understanding the description. It is contemplated that structures may be oriented otherwise.

### DETAILED DESCRIPTION

Another category of customized mats includes floor liners. For the purpose of the present description, these types of mats will be referred to as complex customized mats. Generally speaking, a complex customized mat is a bit thinner and lighter than the typical floor or cargo mat. Further, a complex customized mat will often have a tall outer perimeter wall and rim with a contour design specifically conforming to raised surfaces that surround a particular floor and/or cargo area. In contrast, most standard mats will have a relatively uniform raised wall around its entire outside perimeter. In a complex customized mat of the present disclosure, the perimeter wall extends vertically up and away from a plane that is generally parallel with the bottom surface or base of the floor and/or cargo area. Complex customized mats may include one or more raised walls to help contain undesirable material; complex customized mats also generally have upwardly extending surfaces that extend well above the base surface of the mat in conformance with corresponding vehicle surfaces that surround the bottom vehicle area where the mat is to be installed.

A complex customized mat of the present disclosure is usually made from an ultra-durable material such as a rubberized-plastic material. Usually the material makes the product relatively light in feel as compared to the heavy-duty rubber materials used in many standard floor mats. Many complex customized mats also have more of a stiff feeling than a standard floor mat might have. While the materials utilized in complex customized mats may lead to a product that has a light and relatively stiff feel, they also lead to a product that is generally thinner than a standard mat and yet water tight and effective in protecting the interior of a vehicle.

A thermal process called thermoforming is most commonly utilized to produce complex customized mats. Typically, a plastic sheet is heated to a pliable state, vacuum-suctioned to a mold on one side to form to a specific vehicle-appropriate shape, and then trimmed to create a usable product. The sheet is heated to a high enough temperature that it can be stretched onto the vehicle-specific mold and then cooled to a finished shape. Typically, the side of the sheet that is not in contact with the mold has features that are the inverse of the features on the side of the sheet that is in contact with the mold, as shown in U.S. Pat. No. 7,686,371, which is incorporated herein by reference. A thermoplastic sheet material is typically used in thermoforming. However, utilization of a thermoforming process and materials appropriate for such a process place limitations on design features that can be incorporated into a complex customized mat product.

The drawing figures illustrate three different exemplary embodiments of complex customized mats in accordance with the present disclosure. These complex customized mats illustratively have an especially desirable feel and texture due at least to the fact that they are manufactured from a material having a durometer that makes the product generally less hard compared to a similar product manufactured from a thermoplastic sheet material. This is because, in one embodiment, the complex customized mats shown in the thawing figures are injection molded. By injection molding instead of thermoforming, the door opens to design features and materials that would not be appropriate for, desirable for, or in some cases even a possibility for a thermoforming process.

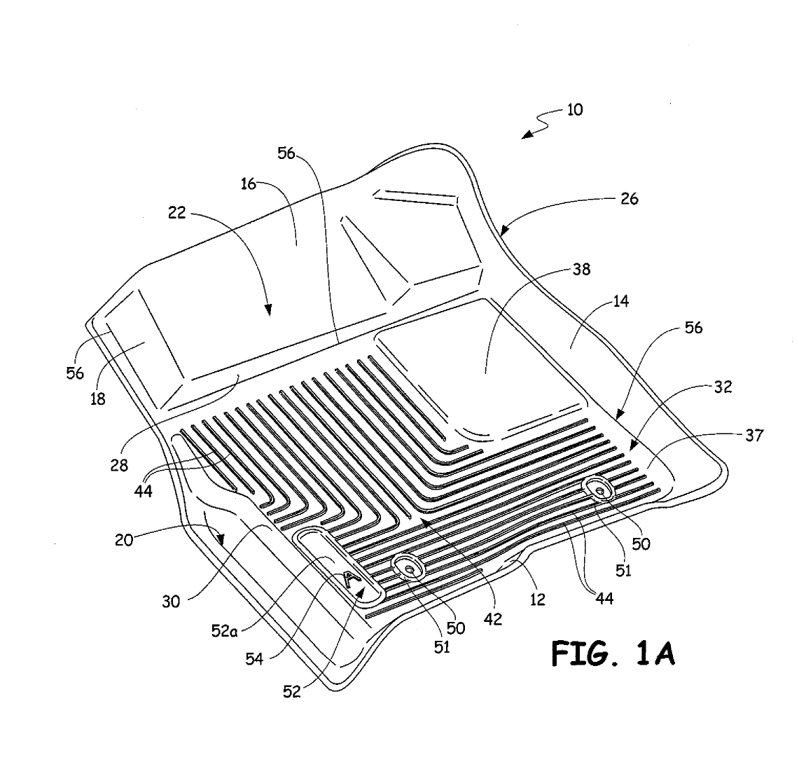

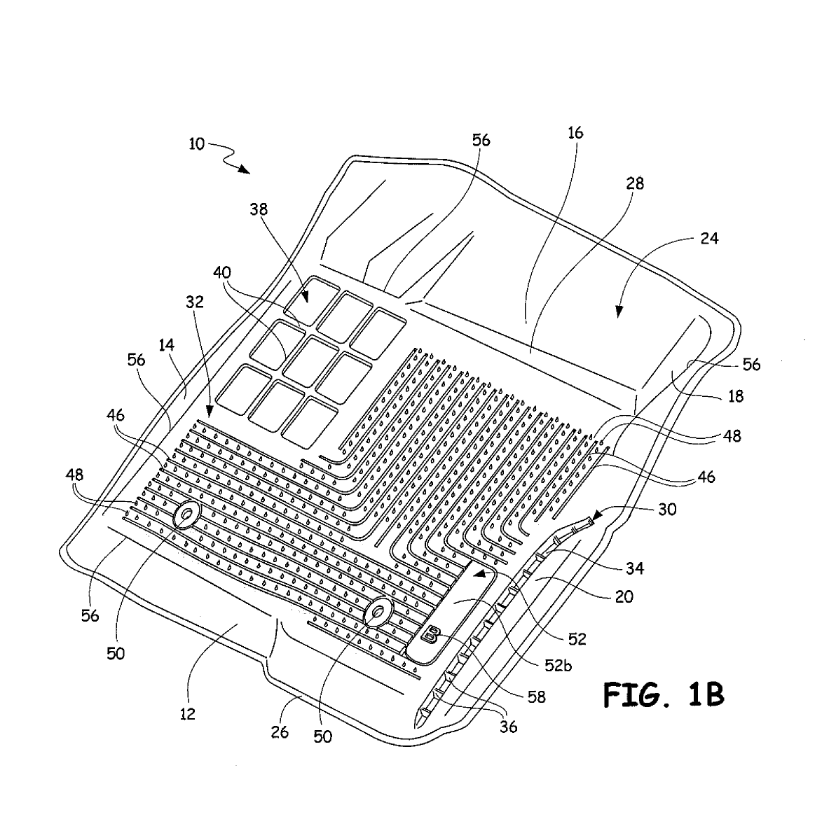

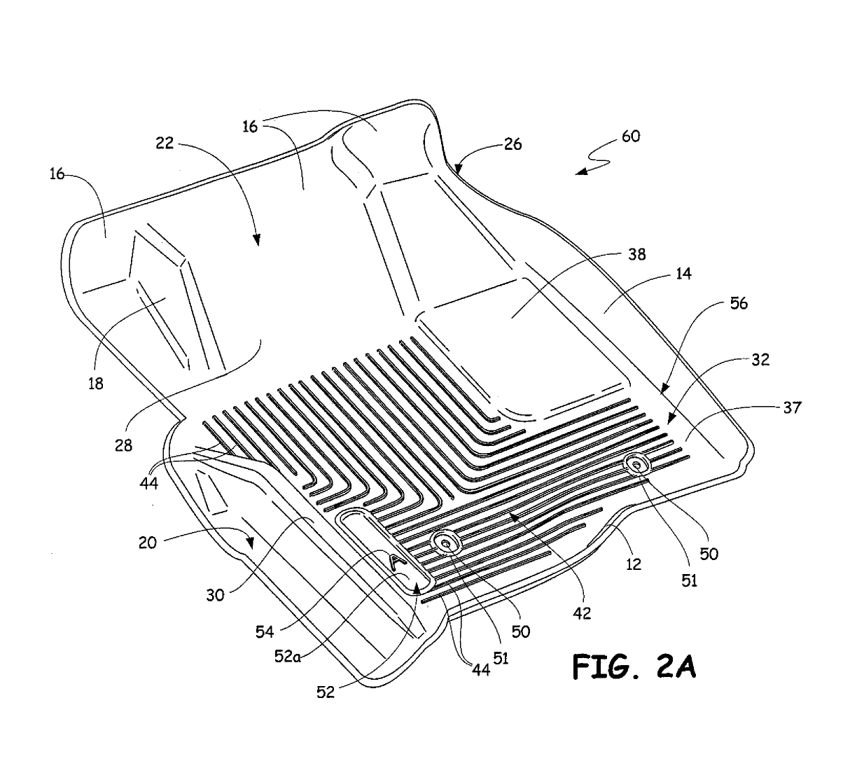

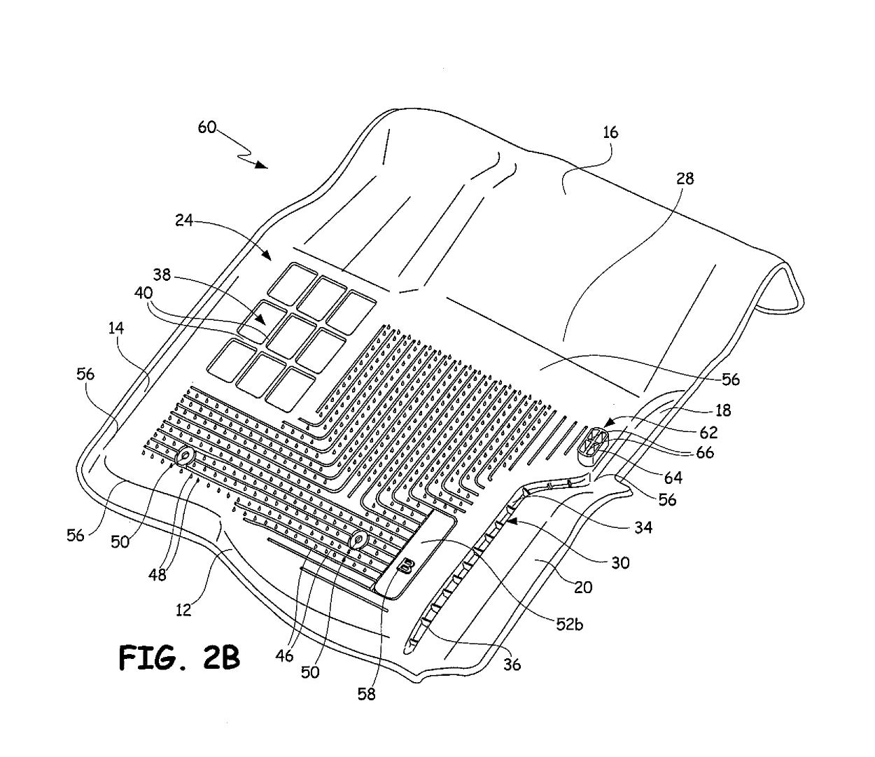

In one embodiment of an injection molding process utilized to produce the complex customized mats like those shown in the drawing figures, material is fed into a heated barrel, mixed, and forced into a mold cavity where it cools and hardens to the configuration of the cavity. In the illustrated cases, the configuration of the cavity is a design that produces the complex customized mats shown in the drawing figures, with the cavity having upper and lower molds to impart molded features to the top and bottom surfaces of the mat, including side walls of the mat. The molds utilized are typically produced by a toolmaker. In an exemplary embodiment, the molds are made of metal (e.g., steel or aluminum) and precision-machined as necessary to form the features of the mat. The mat configuration shown in FIGS. 1A and 1B is different than the mat configuration shown in FIGS. 2A and 2B because each of the illustrated complex customized mats is designed to tightly conform to the intricate surfaces around the floor area of a different vehicle.

FIG. 1A shows a first exemplary embodiment of a complex customized floor mat 10 of the present disclosure. Complex customized mat 10 is specifically shaped to fit the floor contours of a particular vehicle, as designated by make, model and year. The mat 10 of FIGS. 1A and 1B, for example, is designed to fit the contours of the driver's foot well in the 2011 Ford F150 truck. It is to be understood that mats within the scope of the present disclosure may have shapes other than the particular illustrated embodiments, as such mats can be customized to any of a number of different vehicles, as well as different floor portions of the vehicles, such as the driver's foot well, the front passenger's foot well, left and right rear passenger foot wells, cargo areas, and trunk areas, for example.

In the illustrated exemplary embodiment, mat 10 has at its perimeter upwardly sloping rear wall portion 12, upwardly sloping right side wall portion 14, upwardly sloping front wall portion 16, and downwardly sloping left side wall portions 18 and 20. The upwardly sloping perimeter wall portions 12, 14, 16 specifically conform to raised surfaces that surround a particular floor and/or cargo area. Thus, the upwardly sloping perimeter wall portions 12, 14, 16 are distinguishable from the thicker, uniform perimeters common in many substantially flat mats. The downwardly sloping perimeter wall portion 18 and downwardly sloping threshold 20 specifically conform to lower surfaces that surround a particular floor and/or cargo area. When mat 10 is placed in a vehicle, threshold 20 covers the area of the floor surface near the entry/exit location of the vehicle (e.g., the vehicle door), thereby fully protecting the floor surface. Mat 10 includes a top major surface 22, shown in FIG. 1A, and an opposite bottom major surface 24, shown in FIG. 1B. Bottom major surface 24 is configured to lie over and conform to contours of a portion of the floor surface (such as a foot well or cargo area, for example) of a particular vehicle, including any adjacent walls or raised portions, such as, for example, a firewall, inboard transmission panel, seat brackets, or kick panel. Around the perimeter of mat 10, lip 26, comprising a sharply turned edge rim, helps to grip the underlying floor covering (such as carpet) of the vehicle to keep mat 10 in place. In an exemplary embodiment, the edge rim of lip 26 is turned toward bottom major surface 24 so that a smooth, rounded edge is visible on top major surface 22. In one embodiment, the injection molds utilized to form the complex customized mat 10 of the present disclosure are formed so as to create a relatively sharply rolled-over lip 26 (e.g., a “U”-shaped edge around the perimeter like a small hook for added installation security). In one non-limiting embodiment, the return lip 26 is formed around all or a portion of the complex customized mat at a measurement of about 60/1000 inch. Those skilled in the art will appreciate that the return lip 26 could be made any thickness.

Upwardly sloping rear wall portion 12, upwardly sloping right side wall portion 14, upwardly sloping intermediate portion 28 and double wall 30 define containment area 32, which contains debris and other matter to prevent soiling of the vehicle floor covering. Each of upwardly sloping rear wall portion 12, upwardly sloping right side wall portion 14, upwardly sloping intermediate portion 28 and double wall 30 extends generally upward or downward from base 37 of containment area 32. The contours of upwardly sloping rear wall portion 12, upwardly sloping right side wall portion 14, upwardly sloping intermediate portion 28 and threshold 20 are selected to lie over and conform to wall and threshold contours of the foot well of the 2011 Ford F150 truck.

In the illustrated embodiment, double wall 30 is not positioned on the perimeter of mat 10. Rather, double wall 30 is located on top major surface 22 of mat 10 between threshold 20 and containment area 32. As shown in FIG. 1B, double wall 30 comprises a U-shaped channel 34 reinforced with ribs 36. Ribs 36 structurally strengthen double wall 30 to prevent its collapse from forces (such as a person's weight) during use with little material usage or added weight. Such collapse would not only lead to the escape of fluid and debris down threshold 20 (where such fluid and debris is likely to brush against the clothes or shoes of a driver upon entry and exit of the vehicle), but flattening of double wall 30 would also compromise the fit of mat 10 within the foot well of the vehicle. In an exemplary embodiment, a height of each of ridges 44 ranges from between about 50/1000 inch to about 300/1000 inch deep, with an especially suitable height between about 225/1000 and 275/1000 inch deep. This relatively shallow height allows for ease of cleaning of base 37 between ridges 44. In an exemplary embodiment, double wall 30 extends upward from base 37 at to a height greater than a height at which ridges 44 extend upward from base 37 to form a bather between containment area 32 and threshold 20.

Mat 10 further comprises heel pad 38, which in one embodiment comprises a raised portion of containment area 32. Thus, debris will tend to gravitate downward off heel pad 38, thereby protecting the driver's shoe heel and pant leg cuff from excessive soiling. As shown in FIG. 1B, raised heel pad 38 contains reinforcement ribs 40 to structurally strengthen raised heel pad 38 to prevent its collapse from forces (such as a person's weight) during use with little material usage or added weight.

Tread area 42 contains a plurality of raised ridges 44 configured to channel and contain fluid and debris between raised ridges 44. Thus, a person's shoe or pant leg that is in contact with a top surface of raised ridges 44 is protected from the fluid and debris channeled between the raised ridges 44. Any design of the raised ridges 44 capable of blocking or channeling water is considered to be within the scope of the present disclosure. As shown in FIG. 1B, bottom surface 24 of mat 10 may comprise a plurality of ridges 46 and nibs 48 to provide added traction between bottom surface 24 and the vehicle floor surface to prevent slippage of mat 10. In an exemplary embodiment, nibs 48 are tiny protruding nubs, such as small outwardly extruding cone or triangle shaped elements.

In some embodiments, floor clip apertures 50 are provided for engagement with the floor mat clips available in some vehicles. In an exemplary embodiment, ridge 51 is provided to surround each aperture 50, thereby isolating aperture 50 from the remainder of containment area 32. Thus, ridge 51 prevents fluid and other debris from flowing into aperture 50. In other embodiments, floor clip apertures are not needed because the configuration of mat 10 adequately holds it in position without the need for floor clip engagement. An advantage of eliminating the floor clip apertures 50 is that the mat 10 is more water-tight and better protects the underlying vehicle surface.

In an exemplary embodiment, product label 52 carries information that is injection-molded into the mat 10. Accordingly, the mold provided by the toolmaker includes the label information as necessary to effectuate raised lettering 54 as shown in FIG. 1A. Product label 52 may consist of lettering and logos in one or more colors. In the case of multiple colors, material supplies of different colors are provided into the injection molding process in order to create the label 52 having two or more colors. Moreover, it is within the scope of the present disclosure for more than two colors to be included in the label 52 or any other portion of the complex customized mat 10. As shown in FIG. 1B, on bottom side 52b of product label 52 may include information 58 that is different from that on the top side 52a of product label 52. Typically, top side 52a may include the name and logo of the manufacturer of mat 10. Bottom side 52b may include information such as the make, model and year of the vehicle for which the mat 10 is manufactured, the manufacturing date, and lot number, for example. Different information on the two product label sides 52a, 52b are possible because the mold components on each side of the tool utilized to form the complex customized mat 10 can be different. Generally speaking, this is not possible when thermoforming a mat. With thermoforming, information on one side of the mat must be an inverse or opposite representation of what is on the other side. This is because the material is pushed or pulled over a mold rather than formed in a cavity with mold features for both the top major surface 22 and bottom major surface 24 of the mat 10.

In an exemplary embodiment, a mold cavity for mat 10 is formed between two mold halves, as is known in the art. A first mold half is generally configured with the inverse of features on top major surface 22 and the second mold half is generally configured with the inverse of features on bottom major surface 24. However, a blank area may be positioned where a separately molded product label 52 will be inserted into the mold cavity. In an exemplary embodiment, each mold half may be formed of more than one part, so that the parts are interchangeable. For example, a mold for the top major surface 22 of a mat for a particular vehicle A may comprise a front mold section and a rear mold section. In one case, the front section of the mold may also be used with a different rear mold section for another vehicle B. Thus, by forming the mold from interchangeable components, it is possible to form a large number of different mats 10 without the need for machining the same number of whole molds.

In one method of manufacture, product label 52 is molded separately from mat 10 in a color different from the color of the rest of mat 10, including multiple colors. The partially or fully cured product label 52, in the form of an insert, is then inserted into the mold cavity for mat 10. The insert is placed into the mold cavity before the process of injecting material into the mold cavity for forming the remainder of the complex customized mat. The material for forming the remainder of mat 10 is injected so that mat 10 is overmolded around product label 52 and over at least portions of label 52, such as over a perimeter edge of label 52. The mat material flows around the insert such that the colored insert for product label 52 will be integrated into mat 10. Also or alternatively, the insert may be made of a material that softens when encroached upon by the relatively hot injected material being utilized to form the mat 10 within the mold. In this case, the insert and mat materials will cure together to form mat 10. Once cured, mat 10 is removed from the mold.

Using process compatible materials, such overmolding results in a durable, integrated mat and product label, while process controls for producing a more complicated multi-colored product label 52 need not extend to production of the entire mat 10. Moreover, because product label 52 is molded separately from mat 10, if a product label 52 is defective (for example, if the colors are not positioned as desired), the defective label can be scrapped and recycled without affecting production of the entire mat 10. Moreover, the use of a separate mold for product label 52 allows for easily changing the information on the product label without the need for entirely new molds for the remainder of mat 10. While different colors for product label 52 are specifically contemplated, the overmolding teachings herein may also be applied to other portions of mat 10. A multi-color mat 10 produced as described is much more durable than state-of-the-art mats, wherein colored elements are typically applied with adhesive.

In one embodiment, the material utilized to make the complex customized mat 10 of the present disclosure is a thermoplastic elastomer. This is in contrast to a thermoplastic vulcanite, which is more likely to be used in a thermoforming process. Thus, as has been described, the complex customized mat 10 of the present invention is generally softer and more flexible than its thermoformed counterparts. This means that the complex customized mats of the present invention are more likely to drop into vehicle areas where there might be a variance, thus better conforming to the contours of a particular vehicle. For example, one vehicle is likely to have some variance relative to another vehicle of the same make, model and year. The complex customized mats of the present invention are more likely to settle into areas of variance from one vehicle to another. Due to the flexibility of the material relative to the more rigid material associated with a thermoforming process, the tolerance of the complex customized mats of the present invention is greater. In accordance with one aspect of the present disclosure, materials utilized to form the complex customized mats as described herein have a relatively low flex modulus and a low durometer as compared to materials utilized to make a thermoformed mat. Known thermoplastic elastomers are suitable for the injection molding of mat 10, including polypropylene-based thermoplastic elastomers. An especially suitable thermoplastic elastomer material for use in injection molding mat 10 includes, for example, the Tekron® TK-4001-65 thermoplastic elastomer commercially available from Teknor Apex Company of Pawtucket, R.I.

In an exemplary embodiment, a built-up area 56 (i.e., an area where the mat is thicker than in surrounding areas) is provided at intersections between portions that are oriented in different directions, such as, for example, the intersection between base 37 of containment area 32 and each of upwardly sloping rear wall portion 12, upwardly sloping right side wall portion 14, and upwardly sloping intermediate portion 28. By including an increased thickness at such intersections, the complex customized mat 10 becomes generally more robust than a mat produced in a thermoforming process, in which such a build-up is not practically possible.

In accordance with one embodiment of the present invention, a textured finish is incorporated into the injection mold component wherever it is desired for there to be a textured finish on the mat 10. For example, in one embodiment, heel pad 38 includes an aesthetically appealing textured finish that is accomplished by an opposite texture being formed in a surface of the injection mold provided by the toolmaker. It is within the scope of the present invention for any texture to be applied to the surfaces of the complex customized mat 10 of the present disclosure. In one embodiment, the toolmaker chemically etches a texture onto the surface of the mold in order to create a mold that will produce a corresponding texture on the surface of the complex customized mat wherever desired. Such a fine texture may be desirable on a relatively flat area such as front wall portion 16.

FIGS. 2A and 2B show a second exemplary embodiment of a custom floor mat 60 of the present disclosure. Mat 60 includes many of the same features of mat 10, and similar, though not identical, features carry the same reference numbers. All of the descriptions of mat 10 also apply to mat 60. Mat 60 is different from mat 10 because it is especially configured to fit the driver's foot well of a different vehicle. As shown in FIG. 2B, mat 60 includes a foot 62, which raises the front left corner of containment area 32 relative to the vehicle's floor surface, in order to keep containment area 32 flat and prevent fluid and debris from draining to the front left corner of containment area 32. In the illustrated embodiment, foot 62 comprises a perimeter wall 64 with internal ribs 66. Thus, foot 62 possesses structural strength while adding little material or weight. It is contemplated that other foot structures, with configurations, sizes and locations designed to accommodate the floor structures of different vehicles, may be incorporated in any area on the bottom surface 24 of floor mat 60 to raise such areas to desired levels.

As explained above, the injection-molded complex custom mat 10, 60 of the present disclosure overcomes many of the product limitations of traditionally thermoformed mats. For example, because thermoforming uses a vacuum suction process to mold features onto one side of a sheet material, the opposite side necessarily possesses the inverse of the molded features. In contrast, in the injection-molded complex custom mat 10, 60 of the present disclosure, the bottom major surface 24 can have unique features that are not the inverse for the features of the top major surface 22. Such features include, for example, ribs 36 for reinforcing U-shaped channel 34 of double wall 30; reinforcement ribs 40 of raised heel pad 38; bottom surface retention features such as ridges 46 and nibs 48; foot 62 and unique imprinted information on bottom side 52b of product label 52. Moreover, features such as solid ridges 44 and built-up areas 56 are possible because injection molding allows for different thicknesses of material rather than just the shaping of a planar sheet of material. Thus, the mat 10, 60 of the present disclosure possesses more strength, durability and features than current state-of-the-art complex customized floor mats or liners, due to features that are not possible with traditional thermoforming. Moreover, with thermoforming, where a feature is added to a thermoformed mat, there is some degree of thinning of material where the feature is forced over the mold. For example, ridges 44 shown in FIG. 1A are generally thicker and more robust than similar foot treads that might be included in a thermoformed floor mat because the injection molded foot treads will not experience the same thinning that will necessarily occur due to the draw around the mold in the thermoforming process.

Front portion 54 extends upwardly to protect a front of the vehicle foot well. When the vehicle brakes are applied, any water or other fluid in containment area 32 is likely to slosh forward toward area 54. However, escape of the fluid beyond the front of mat 10 is prevented by the barrier formed at upwardly sloping intermediate portion 28.

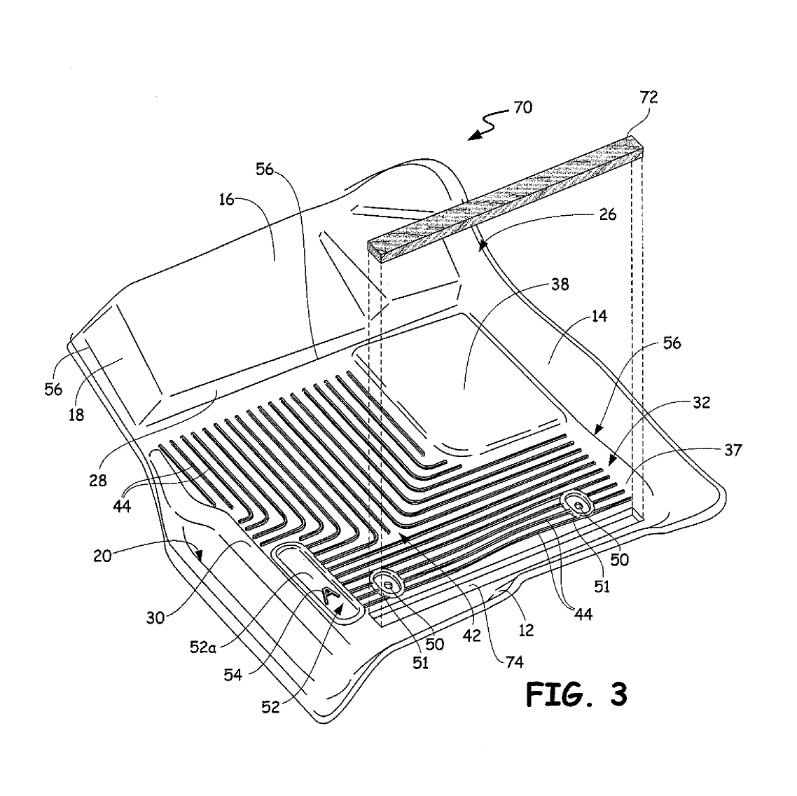

FIG. 3 shows a third exemplary embodiment of a complex customized mat 70 incorporating an absorbing mechanism to prevent sloshing of fluid when the vehicle brakes are applied. Mat 70 is similar to mat 10 of FIGS. 1A and 1B but additionally incorporates a fluid absorbing mechanism such as sponge 72 proximate upwardly sloping rear wall portion 12. In an exemplary embodiment, sponge 72 is removable for service (e.g., wringing it out or otherwise drying it) or replacement. In an exemplary embodiment, sponge 72 is disposed in a recessed area 74, which forms a receptacle to retain sponge 72. In other embodiments, similar sponge areas may be positioned on other areas of mat 70, such as proximate any of upwardly sloping right side wall portion 14, upwardly sloping intermediate portion 28 and/or double wall 30, for example. Such placement in most instances will correspond with the lowest area of the floor well, which will differ in location depending on the vehicle make, model and year. In another exemplary embodiment, the receptacle for sponge 72 is not recessed into base 37 but is rather a ridge-bordered area defined on base 37.

Although the subject of this disclosure has been described with reference to several embodiments, workers skilled in the art will recognize that changes may be made in form and detail without departing from the spirit and scope of the disclosure. In addition, any feature disclosed with respect to one embodiment may be incorporated in another embodiment, and vice-versa.

What is claimed is:

1. An apparatus comprising:
a bottom major surface configured to lie over and conform to contours of a vehicle floor surface;
a top major surface opposite the bottom major surface, the top major surface comprising a base;
an upwardly sloping wall portion extending from the base, the upwardly sloping wall portion configured to lie over and conform to upwardly sloping contours of a vehicle surface; and
a double wall disposed on the base at a location that is not on a perimeter of the apparatus, wherein the double wall comprises a plurality of ribs on the bottom major surface.

2. The apparatus of claim 1 further comprising a threshold disposed adjacent the double wall.

3. The apparatus of claim 2 wherein the threshold slopes downward.

4. The apparatus of claim 1 further comprising a receptacle for a fluid absorbing mechanism.

5. The apparatus of claim 4 further comprising a fluid absorbing mechanism disposed in the receptacle.

6. The apparatus of claim 5 wherein the fluid absorbing mechanism is a sponge.

7. The apparatus of claim 6 further comprising a product label having a top side on the top major surface and having a bottom side on the bottom major surface, wherein information disposed on the top side is different from information disposed on the bottom side.

8. The apparatus of claim 1 further comprising a heel pad that is raised on the top major surface, wherein the heel pad comprises a plurality of reinforcement ribs on the bottom major surface.

9. The apparatus of claim 1 further comprising a plurality of nibs disposed on the bottom major surface.

10. The apparatus of claim 1 further comprising a plurality of raised ridges configured to channel liquid disposed on the top major surface.

11. The apparatus of claim 10 wherein a height of each of the plurality of raised ridges is less than a height of the double wall.

12. The apparatus of claim 1 comprising a polypropylene-based thermoplastic elastomer.

13. The apparatus of claim 1 further comprising an area of increased thickness at an intersection of the base and the upwardly sloping wall portion.

14. A method of forming an apparatus comprising:
molding a label;
inserting the molded label into a mold cavity;
injecting a thermoplastic elastomer into the cavity to overmold the thermoplastic elastomer over at least portions of the label;
curing the thermoplastic elastomer to form a mat with an integral label; and
removing the mat from the mold, wherein the mat comprises:
a bottom major surface configured to lie over and conform to contours of a vehicle floor surface;
a top major surface opposite the bottom major surface; and
an upwardly sloping wall portion extending from the top major surface, the upwardly sloping wall portion configured to lie over and conform to upwardly sloping contours of a vehicle surface.

15. The method of claim 14 further comprising curing the molded label before inserting the molded label into the cavity.

16. The method of claim 14 wherein the molded label and the thermoplastic elastomer cure simultaneously.

17. The method of claim 14 wherein molding the label comprises molding the label from more than one color of material.

18. The method of claim 14 wherein the thermoplastic elastomer comprises polypropylene.
